(19) United States
(12) Patent Application Publication
(10) Pub. No.: US 2010/0012881 A1
(43) Pub. Date: Jan. 21, 2010

(54) METHOD FOR MANUFACTURING MAGNETIC SHEET AND MAGNETIC SHEET

(75) Inventor: Keisuke Aramaki, Tochigi (JP)

Correspondence Address: K&L Gates LLP, P.O. Box 1135, CHICAGO, IL, 60690, US

(73) Assignee: SONY CHEMICAL & INFORMATIOIN DEVICE CORPORATION, Tokyo (JP)

(21) Appl. No.: 12/439,114

(22) PCT Filed: Apr. 5, 2007
(86) PCT No.: PCT/JP2007/057682

§ 371 Date: Feb. 26, 2009

(30) Foreign Application Priority Data
Aug. 31, 2006 (JP) 2006-236471

(51) Int. Cl. H01F 1/12; B05D 5/12

(52) U.S. Cl. 252/62.53; 427/130

(57) ABSTRACT

In manufacturing a magnetic sheet, the magnetic sheet is formed by applying on a prescribed substrate a magnetic paint made from a mixture of at least flat soft magnetic powder and polymeric binder dissolved in a solvent and drying the magnetic paint. Subsequently, the magnetic paint is further coated on the magnetic sheet formed by drying the magnetic paint and is dried. Thus, an extremely high quality magnetic sheet is made with high productivity.

### TECHNICAL FIELD

The present invention relates to a method for manufacturing a magnetic sheet suitable for IC cards or IC tags reducing electromagnetic wave noises and to a magnetic sheet manufactured by this manufacturing method.

### BACKGROUND OF THE INVENTION

Recently, a system performing individual managements, or so-called RFID (Radio Frequency IDentification), has been introduced to the various industries. This RFID system is a technology to make wireless communications between a small non-contact integrated circuit (hereinafter referred to as “IC”) device storing various data readable and writable and having telecommunication function, so-called a transponder, and a predetermined reader/writer and to read and/or write data without any contacting the transponder. Specifically, in the RFID system, on the basis of the principle of electromagnetic induction, in accordance with the release of the magnetic flux from a loop antenna on a reader/writer side, released flux is magnetically coupled with the loop antenna on the transponder side by induction coupling and communications are carried out between the transponder and the reader/writer. This RFID system is expected for various purposes, for instance, such as usages in production and logistics by forming a transponder as an IC tag and attaching this IC tag to products, usages in transportation fare collection, usage for identification cards for entering and leaving a building, and electronic monies.

Such an RFID system does not need to mount an IC card onto a reader/writer or to contact the IC card with a metal contact likewise a conventional contact type IC card system, and can read or write data easily at a high speed. Moreover, in the RFID system, necessary electric power is supplied to a transponder from the reader/writer by electromagnetic induction, so that it is not necessary to incorporate power supplies such as batteries or the like in the transponder, and so that the system can enjoy advantages of providing the transponder with high reliability despite its simple structure and low-cost.

However, in the RFID system, when other metal objects surround the transponder, problems may occur in its communication in response to their influence. In an electromagnetic induction type, when other metal objects surround the transponder, a resonant frequency shifts and flux changes occur due to inductance change in response to the influence, and this leads to a failure to ensure electric power. Therefore, in the RFID system, the loop antenna, which can radiate electromagnetic field with a certain level of magnetic field strength, needs to be disposed on a transponder side to ensure an enough communication range between the transponder and the reader/writer.

In this instance, it is effective to use, for example, magnetic materials for reducing influences from metal objects on the loop antenna with a method other than space arrangements. This enables to reduce the influences from metal objects and make a communication distance larger. Although in recent communication devices and electronic equipments, radiation degrees of noise electromagnetic wave become increased as clock frequencies become higher, and malfunction of the device itself due to external or internal interferences or harmful effects or the like to peripheral devices have occurred, the magnetic materials are effective for preventing occurrences of these electromagnetic wave interferences. Under such circumstances, various types of compound magnetic sheets (soft magnetic sheets) in which a proper quantity of, e.g., soft magnetic powder is dispersed and mixed in a binder such as rubbers or plastics have been proposed.

Conventionally, the following steps generally have been made to manufacture this kind of magnetic sheets. Namely, to manufacture the magnetic sheet, first, magnetic paint is made by mixing a soft magnetic powder, a polymeric binder, and a solvent, then the mixture is coated onto a PET (polyethylene terephthalate) for releasing by using a coater to form a single-layered magnetic sheet. Subsequently, the magnetic sheet formed on the PET for releasing is separated to be accumulated in a plural number of sheets. Finally, the accumulated plural magnetic sheets are compressed by using a laminating machine or a pressing machine to manufacture the magnetic sheet as the final product.

In the meantime, recently, mobile communication equipments such as cellular handsets are produced with a thinner size, lighter weight, and lower costs, and according to this trend, thin and high-performance magnetic sheets have been required. Here, ferrite is known as a magnetic material suitable for the purpose of weight reduction. Although the ferrite is known as a magnetic material suitable for rendering the device lighter, the ferrite raises a problem on being fragile and extremely low-impact-resistance because the ferrite is a brittle material in a case where used as a magnetic sheet for a mobile communication equipment. Thus, magnetic sheets formed thinly by dispersing soft magnetic powder in a resin with excellent magnetic characteristics have been required.

As a method for manufacturing such magnetic sheets, a method of coating by dissolving a flat magnetic powder and a polymeric binder into a solvent has been proposed (see e.g., Patent Document #1). Patent Document #2 discloses a method for manufacturing a compound magnetic material by compressing, upon forming an undulated surface of plural compound magnetic sheets formed by mixing a soft magnetic powder into a polymeric binder, the compound magnetic sheets with two rollers facing to each other.

Patent Document #1: Japanese Unexamined Patent Application Publication No. 2000-4097

Patent Document #2: Japanese Patent Publication No. 3722392

In a conventional method for manufacturing magnetic sheet, however, there raise problems such that the plural magnetic sheets are accumulated in a misaligned state and that the manufacturing steps becomes long with poor productivity, because the conventional method is accompanied with a step of accumulating plural sheets after separating the magnetic sheet from PET for releasing.

With the conventional method for manufacturing magnetic sheets, situations involving air among the overlapping magnetic sheets have frequently occurred as accumulating the magnetic sheets. Therefore, the magnetic sheets manufactured by such a manufacturing method raise a problem that under a high-temperature environment or a high temperature and high humidity environment, air involved in the magnetic sheets expands to make the thickness of the magnetic sheets thicker as a change.

Furthermore, in the conventional method for manufacturing magnetic sheets, there raises a problem to render the appearance worse due to ejection of air involved among the magnetic sheets at the surface where the magnetic sheets are compressed at high pressure to make magnetic characteristics better. On the contrary, where the appearance is tried to be not worse, there still raises a problem that the magnetic characteristics may be deteriorated due to a failure in providing a high pressure at the time of compression.

In the conventional method for manufacturing magnetic sheets, there raises a problem that the magnetic paint may not be coated smoothly due to blurs to render the thickness in the surface more uneven where the magnetic paint is coated further on the formed magnetic sheet.

The present invention is made in consideration of the above situations, and it is an object to provide a method for manufacturing a magnetic sheet that can manufacture a magnetic sheet with extremely high quality and high productivity, and a magnetic sheet manufactured by using this manufacturing method.

### SUMMARY

As a result of diligent study on manufacturing method of a magnetic sheet, the inventor of this application has discovered a method for manufacturing a magnetic sheet having a good appearance and magnetic characteristics with high productivity, and has accomplished this invention.

That is, the method for manufacturing a magnetic sheet according to this invention for accomplishing the object aforementioned, comprises the steps of: coating, on a predetermined substrate, a magnetic paint made from a mixture of an at least flat soft magnetic powder and a polymeric binder dissolved in a solvent and drying the magnetic paint to form a magnetic sheet; and further coating and drying the magnetic paint on the magnetic sheet dried to be formed.

The magnetic sheet according to this invention for accomplishing the object aforementioned comprising a magnetic paint made from a mixture of an at least flat soft magnetic powder and a polymeric binder dissolved in a solvent, wherein the magnetic sheet is made by coating and drying the magnetic paint on the magnetic sheet formed by drying the magnetic paint after coating the magnetic paint on a predetermined substrate.

With the present invention, this method can solve a problem in which the magnetic sheets are accumulated in a misaligned state as in the conventional manufacturing method by accumulating and thermally compressing the plural magnetic sheets, can reduce air involved among the magnetic sheets. The present invention therefore can simplify the step of discharging the air by compression, improve the productivity, and suppress a problem in which the magnetic sheet changes its thickness due to air involved among the magnetic sheets under high temperature environment or high temperature and high humidity environment. The present invention further can manufacture the magnetic sheet with high magnetic permeability while maintaining an excellent appearance without leaving any scar due to air ejection even if compressed at a high-pressure because air involved among the magnetic sheets is a quite small amount.

According to this invention described above, the magnetic sheet with an extremely high quality in appearance as well as magnetic characteristics can be manufactured with high productivity.

### DETAILED DESCRIPTION

Hereinafter, specific embodiments to which the present invention applies will be described in detail with reference to the drawings.

This embodiment illustrates a method for manufacturing a magnetic sheet suitable for use in, e.g., IC (Integrated Circuit) cards and IC tags used in so-called RFID (Radio Frequency IDentification) systems. Particularly, this method for manufacturing the magnetic sheet can eliminate a problem due to air involved among the magnetic sheets likewise in the conventional manufacturing method in which adjusting the thickness by accumulating the plural magnetic sheets, and can manufacture the magnetic sheet having an extremely high quality with high productivity.

Initially, to manufacture a magnetic sheet, magnetic paint is made by mixing at least flat soft magnetic powder into a polymeric binder dissolved in a solvent, and then the magnetic paint is dried after coated on a predetermined substrate to form a magnetic sheet.

Here, as a magnetic material forming a flat soft magnetic powder, any soft magnetic material can be used, and such as, e.g., magnetic stainless steel (Fe—Cr—Al—Si based alloy), Sendust (Fe—Si—Al based alloy), Permalloy (Fe—Ni based alloy), silicon copper (Fe—Cu—Si based alloy), Fe—Si based alloy, Fe—Si—B (—Cu—Nb) based alloy, Fe—Ni—Cr—Si based alloy, Fe—Si—Cr based alloy, Fe—Si—Al—Ni—Cr based alloy are suitable. The magnetic sheet manufactured with the soft magnetic powder made from these soft magnetic materials is suitable for use in RFID systems or electronic wave absorbers since the soft magnetic powder is excellent in soft magnetic characteristics.

Although a flat shaped soft magnetic powder is used as a soft magnetic powder, it is desirable to use a magnetic powder having a length in the major axis direction of 1 to 200 μm and a flat ratio of 10 to 50. Sieves or the like may be used to classify sizes of soft magnetic powders, as necessary, for making the sizes of flat soft magnetic powder uniformed.

A soft magnetic powder subjected to a coupling treatment in use of a coupling agent such as, e.g., silane coupling agent may be used for the soft magnetic powder. Use of the coupling-treated soft magnetic powder can enhance reinforcing effects at the interfaces between the flat soft magnetic powder and the polymeric binder and can improve specific gravity and corrosion resistance. For example, γ-methacryloxypropyl trimethoxysilane, γ-glycidoxypropyl trimetoxysilane, and γ-glycidoxypropylmethyl diethoxysilane are exemplified for the coupling agent. Furthermore, the coupling treatment can be done by making coupling to the soft magnetic powder in advance or can be done by mixing the agent at the same time that mixing soft magnetic powder and binder to perform the coupling treatment subsequently.

On the other hand, polyester based resin, polyurethane resin, epoxy resin and copolymer of those can be used as a binder (polymeric binder). Particularly, polyester based resin, which is a resin having a good processing property and rendering the flat soft magnetic powder orient in a high density, can be used as a binder. Phosphorus-containing polyester based resin having phosphoric residue can be used for polyester based resin used as a binder. The magnetic sheets can be rendered with flame resistance by using this phosphorus-containing polyester based resin.

The phosphorus-containing polyester based resin as described above contains phosphoric residue in the molecule, and phosphorus denatured saturated polyester copolymer can be exemplified as a specific example. Phosphorus denatured saturated polyester copolymer is a material in which phosphorus component is introduced into a main chain of saturated polyester copolymer, and can be obtained by copolymerizing a polyester component and a phosphorus component. As polyester components, e.g., a polymer compound formed of ethylene glycol and terephthalic acid, naphthalene carboxylic acid, adipic acid, sebacic acid, or isophthalic acid, a polymer compound formed of 1,4-butane diol and terephthalic acid, adipic acid or sebacic acid, and a polymer compound formed of 1,6-hexane diol and adipic acid, sebacic acid, or isophthalic acid, can be used. As phosphorus components, e.g., phosphonate type polyol, phosphate type polyol, vinyl phosphonate, allyl phosphonate can be used. Thus, polyester copolymers introduced with phosphorus components into its main chain has a higher flame resistance than a material in which phosphorus component is merely mixed and dispersed to polyester.

The phosphorus containing rate of the phosphorus-containing polyester based resin can be so determined as to satisfy a prescribed flame resistance in accordance with the kind of the main chain of the polyester based resin, the kind of the phosphorus component (phosphoric residue), the kind of other components forming the magnetic sheet, and the phosphorus containing rate is from 0.5 weight percent to 4.0 weight percent. The flame resistance is low if the phosphorous containing rate is less than 0.5 weight percent, and a sufficient flame resistance cannot be obtained unless a flame retardant is added so much. If the phosphorus containing amount exceeds 4.0 weight percent, the molecular weight of the polyester based resin cannot be large, so that its mechanical strength may be deteriorated.

A number average molecular weight of phosphorus containing polyester based resin is preferably between 8,000 and 50,000. The mechanical strength of the obtained magnetic sheet may be insufficient if the number average molecular weight is less than 8,000. On the other hand, if the number average molecular weight is greater than 50,000, the obtained magnetic sheet is too hard to obtain desired flexibility. A glass transition temperature of the phosphorus containing polyester based resin is preferably between −20 and 40 degrees Celsius. Elastic modulus descends under a high temperature if the glass transition temperature is equal to or less than −20 degrees Celsius, and adhesive force among soft magnetic powders deteriorates under the high temperature environment or high temperature and high humidity environment. If the glass transition temperature exceeds 40 degrees Celsius, the magnetic sheet becomes harder at the room temperature.

Dispersed particles not dissolved in the polyester based resin as a binder but dispersed in the polyester based resin, may be added to the magnetic paint. These dispersed particles make a surface of the magnetic sheet smooth and provide a good appearance to the magnetic sheet without any ejection scar of air contained in the polyester based resin when compressed in a subsequent step. The dispersed particles desirably have an insulating property. If the dispersed particles make a flame retardant, a flame resistance can be given to the magnetic sheet.

As flame retardant, any retardant can be used arbitrarily, and zinc based flame retardant, nitrogen based flame retardant, and hydroxide based flame retardant are exemplified. Furthermore, magnesium hydroxide, and aluminum hydroxide are exemplified. As zinc based flame retardant, zinc carbonate, zinc oxide, and zinc borate are exemplified, and zinc carbonate, inter alias, is preferable. As nitrogen based flame retardant, for instance, melamine derivatives such as, e.g., melamine (cyanuric triamide), ammeline (cyanuric diamide), ammelide (cyanurid monoamide), melam, melamine cyanurate, and benzoguanamine can be used. It is desirable to use melamine cyanurate from a viewpoint to dispersibility and mixing property to polyester based resin. Carbon black, titanium oxide, boron nitride aluminum nitride, and alumina may be added in lieu of flame retardants.

It is preferable that the weight of the dispersed particles is not more than seven-thirteenth ( 7/13) of the weight of polyester based resin. If the weight of the dispersed particles added without dissolved to polyester based resin, is not more than seven-thirteenth of the weight of the polyester based resin, it can suppress dimensional changes in thickness of the magnetic sheet under the high temperature environment or high temperature and high humidity environment while maintaining good magnetic characteristics, and the sheet can obtain a good processability. On the other hand, if the weight of the dispersed particles is more than seven-thirteenth ( 7/13) of the weight of the polyester based resin, the dimensional changes in thickness may be prevented from occurring under the high temperature environment or high temperature and high humidity environment, but the processability becomes deteriorated.

It is preferable that the particle diameter of the dispersed particles not dissolved in but dispersed to the polyester based resin is between 0.01 μm and 15 μm. If the particle diameter of the dispersed particles is less than 0.01 μm, an advantage to restrain changes in thickness cannot be obtained. If the particle diameter of the dispersed particles is not smaller than 15 μm, the magnetic characteristic becomes deteriorated.

Although the magnetic sheet has a specific gravity becoming large by discharging the air in the resin when manufactured by compression, escape ways of air are generally limited by the compression. Soft magnetic powders blended in a large amount may be accumulated, and a binder cannot reach extremely thin interspaces, so that air gaps inevitably remain in the sheet. To the contrary, since the magnetic sheet adding the dispersed particles is formed smoothly, the amount of involved air in the magnetic sheet can be reduced, and its specific gravity can be increased. That is, the magnetic sheet can achieve good magnetic characteristics. With the magnetic sheet, flame resistance can be further improved, since the air amount contained inside decreases as the specific gravity increases by compression.

The magnetic sheet may contain a cross-linking agent in addition to the soft magnetic powder and the polyester based resin as a binder. As a cross-linking agent, for example, blocked-isocyanate is exemplified. Blocked-isocyanate is an isocyanate compound protected with a protecting group that can be dissociated (de-protected) by heating so as not to react isocyanate group (—NCO) at a room temperature. This blocked-isocyanate does not crosslink the polyester based resin at a room temperature, but does crosslink the polyester based resin in dissociating the protecting group and in rendering the isocyanate group active, when heated at a temperature equal to or higher than the dissociating temperature of the protecting group.

It is to be noted that it is preferable to use a blocked isocyanate with a protecting group having a dissociating temperature range from 120 to 160 degrees Celsius. By setting this dissociating temperature to a temperature higher than 120 degrees Celsius, methyl ethyl ketone and toluene for adjusting viscosity of the magnetic paint coated on a substrate can be evaporated used, and the formed magnetic sheet can be dried. On the other hand, in a case where the dissociating temperature is less than 120 degrees Celsius, crosslinkage of the polyester base resin can be promoted due to dissociation on the protecting group of blocked isocyanate when the magnetic paint is dried at a temperature equal to or higher than a boiling point of methyl ethyl ketone and toluene after the magnetic paint is coated on a substrate. Because a film used for the substrate has a heat resistant temperature equal to or lower than 160 degrees Celsius, the dissociating temperature is preferably at 160 degrees Celsius or lower. Because reaction crosslinking the polyester based resin proceeds slowly even at a room temperature, the polyester based resin completely crosslinks to harden the binder thoroughly by chilling the entire resin to the room temperature after heated and then by leaving the resin for a long time.

Blocked isocyanate is preferably blended equal to or more than 0.5 weight percent with respect to the polyester based resin serving as a binder. This can bring adequate effects. If the blended amount of the blocked isocyanate is less than 0.5 weight percent, the crosslinkage may become insufficient, and the thickness may change largely under high temperature or high humidity environments.

In a case where unprotected isocyanate is used, the crosslinkage of the polyester based resin may proceed when the sheet is formed by coating the magnetic paint on a substrate and drying the solvent, so that good magnetic characteristics may not be obtained even by compression. The sheet tends to have changes with thicker thicknesses because the already cured resin is subject to compression.

Here, it is not easy to fill, upon mixing the flat soft magnetic powder with the polyester based resin as a binder, the mixture in a high density. This is because loads during mixing may cause the soft magnetic powders to be milled and to have a powder size smaller, or may cause magnetic permeability μ′ to be decreased upon reception of large stresses, where the flat soft magnetic powder is mixed with the binder. Thus, the polymeric binder dissolved in the solvent is used to mix the flat soft magnetic powder with the binder; a magnetic paint is formed by mixture in not providing any load to the flat soft magnetic powder as much as possible; and the magnetic sheet is desirably manufactured by coating this paint on the substrate.

It is to be noted that when the magnetic paint is coated, the flat soft magnetic powder is advantageously oriented and arranged in an in-plane direction by adding a magnetic field, so that the flat soft magnetic powder can be filled in a high density. A compressing step to compress the dried magnetic sheet may be used to improve specific gravity. The magnetic sheet may have an improved flame resistance, because the air amount contained inside the sheet is reduced by making the specific gravity greater.

A material in a film form can be used as a substrate, and for example, polyethylene terephthalate film, polyethylene naphthalate film, polyimide film, polyphenylene sulfide film, polypropylenoxide film, polyethylene film, polypropylene film, and polyamide film are exemplified. The thickness is selectable as appropriate, and for example, a thickness from several microns to several hundreds microns can be selected. A mold releasing agent may be coated on a formed side of the magnetic sheet.

It is desirable to use a resin having a high fluidity as the binder to easily orient the powder, and it is desirable to make a magnetic paint having a prescribed viscosity upon dissolving the binder in the solvent. For adjusting the viscosity of the magnetic paint, various solvents can be used, and such as, e.g., aromatic hydrocarbon compounds such as benzene, toluene, and xylene, and such as, e.g., methyl ethyl ketone, cyclohexanone, and methyl isobutyl ketone can be used.

The viscosity of the magnetic paint may be adjusted so that coating is done by using coater or doctor blade method, but if the viscosity of magnetic paint is too low, there raises a problem that the specific gravity becomes small when the paint is made into the sheet because the component of the binder increases. The solid component is desirably in a range of 50 to 70 percent. If the magnetic paint has a high viscosity and a solid component equal to or higher than seventy percent, coating cannot be done, and inconveniences such that the sheet is suffered from lines or blurs during coating may occur. If the solid component is equal to or lower than fifty percent, there raises a problem that a mold releasing agent may cause cissing on the substrate when the magnetic paint is coated on the substrate.

In the method for manufacturing the magnetic sheet shown as the embodiment of the present invention, the magnetic paint thus made is prepared, and the magnetic sheet is formed by coating the magnetic paint on a prescribed substrate in application of a coater or a doctor blade method with a suitable thickness and then drying the paint. It is preferable to dry the magnetic paint so that the containing amount of the solvent is equal to 1 percent or lower. If the solvent containing amount is equal to or higher than one percent, the magnetic sheet may be extended or torn off when the dried magnetic sheet is peeled off from the substrate, and vaporized solvent may appear as blisters on the magnetic sheet surface. Where a cross-linking agent is contained, the drying temperature after coating is set at a temperature lower than the crosslinking start temperature of the crosslinking agent. In this manufacturing method, the magnetic paint is further coated on the dried and formed magnetic sheet and is dried in substantially the same manner. In this manufacturing method, thickness of the magnetic sheet is adjusted by repeating such steps. Moreover, in this manufacturing method, where the crosslinking agent is contained, the dried and formed magnetic sheet may be compressed at a temperature equal to or higher than the glass transition temperature of the binder and lower than the reaction start temperature between the binder and the crosslinking agent, and may be further compressed at a temperature equal to or higher than the reaction start temperature of binder and cross-linking agent.

As described above, the method for manufacturing the magnetic sheet illustrated as the embodiment of the present invention includes the steps of coating, on a predetermined substrate, a magnetic paint made from a mixture of an at least flat soft magnetic powder and a polymeric binder dissolved in a solvent and drying the magnetic paint to form a magnetic sheet, and further coating and drying the magnetic paint on the magnetic sheet dried to be formed, thereby solving a problem that the magnetic sheets are accumulated in a misaligned state as in the conventional manufacturing method in which plural magnetic sheets are accumulated and thermally compressed, and so that air involved among the magnetic sheets can be reduced. Accordingly, with this manufacturing method, the step of discharging air by compression can be simplified, and the method can enjoy the improved productivity, so that the method can suppress the problem that the thickness of the magnetic sheet changes under the high temperature environment or high temperature and high humidity environment caused by the involved air. With this manufacturing method, because the involved air is a so small amount, the magnetic sheet can maintain an excellent appearance without leaving any air ejection scar even where compressed at a high pressure, and can be produced with a high magnetic permeability

### EXAMPLES

The inventor of the present application actually manufactured the magnetic sheet and carried out an environmental test under the high temperature environment of 85 degrees Celsius as well as under the high temperature of 60 degrees Celsius and high humidity environment of 95 percent, and measured the appearance after the environmental test and magnetic characteristics (magnetic permeability μ′, magnetic loss μ″, Q value) before and after the environmental test.

Specifically, in Example 1 and Comparative Examples 1 and 2, magnetic paint was prepared, which was manufactured by using a Fe—Si—Al based alloy powder (MATE CO., LTD. made) as a flat soft magnetic powder, a polyester based resin formed of a mixture of phosphorus-containing polyester based resin (Byron 537; TOYOBO CO., LTD. made) and phosphorus-containing polyester urethane resin (Byron NHV-1; TOYOBO CO., LTD. made) at a mixing ratio of 8:2 as binder, and a blocked isocyanate (Coronate 2507; NIPPON POLYURETHANE INDUSTRY CO., LTD. made) as a crosslinking agent, and a silane coupling agent (SH6040; DOW CORNING TORAY CO., LTD. made).

In Examples 2 and 3, Comparative Examples 3 and 4, magnetic paint was prepared, which was manufactured by using a Fe—Si—Al based alloy powder (MATE CO., LTD. made) as a flat soft magnetic powder, a polyester based resin formed of a mixture of phosphorus-containing polyester based resin (Byron 537; TOYOBO CO., LTD. made) and phosphorus-containing polyester-urethane resin (Byron NHV-1; TOYOBO CO., LTD. made) at a mixing ratio of 8:2 as a binder, a blocked-isocyanate (Coronate 2507; NIPPON POLYURETHANE INDUSTRY CO., LTD. made) as a crosslinking agent, a silane coupling agent (SH6040; DOW CORNING TORAY CO., LTD. made), and melamine-cyanurate (MC610; NISSAN CHEMICAL INDUSTRIES, LTD. made) as dispersed particles for reducing an air amount contained in the magnetic sheets.

Subsequently, in Examples 1 to 3, the magnetic sheet was manufactured by using the manufacturing method proposed in the present invention, and in Comparative Examples 1 to 4, the magnetic sheet was manufactured by using the conventional manufacturing method in which plural magnetic sheets are accumulated and thermally compressed. The appearances of the manufactured magnetic sheets were examined, and “G (good)” was given to evaluations for the status in which the surface was not undulated with leaving no air ejection scar, and “NG (not good)” was given to evaluations for the status in which the surface was undulated with some air ejection scars. With respect to the magnetic characteristics, magnetic permeability μ′ is classified in three types: “equal to or higher than 70”, “equal to or higher than 60 and lower than 70”, and “lower than 60”, and “VG (very good)”, “G”, “NG” are assigned for evaluations, respectively. As a change rate in thickness of the magnetic sheet before and after the environmental test, five percent or less makes a required criteria as products. This result is illustrated in the following Tables 1 and 2.

TABLE 1

| | | Example 1 | | Comparative Example 1 | | Comparative Example 2 | |
|---|---|---|---|---|---|---|---|
| Fe—Si—Al based alloy powder | | 465 | | 465 | | 465 | |
| Phosphorus-containing | | 100 | | 100 | | 100 | |
| polyester based resin | | | | | | | |
| Block isocyanate | | 3 | | 3 | | 3 | |
| Silane coupling agent | | 10 | | 10 | | 10 | |
| IPA | | 50 | | 50 | | 50 | |
| Flame retardant | | 0 | | 0 | | 0 | |
| Pressing pressure (kgf/cm²) | | 5.9 | | 5.7 | | 4.3 | |
| Appearance | | G | | NG | | G | |
| Environmental test | | 85° C. | 60° C./95% | 85° C. | 60° C./95% | 85° C. | 60° C./95% |
| conditions | | | | | | | |
| Pre environmental test | | 0.475 | 0.478 | 0.485 | 0.49 | 0.482 | 0.489 |
| thickness (mm) | | | | | | | |
| Magnetic | μ′ | 68.47 | 67.57 | 63.2373 | 62.9027 | 54.53 | 54.31 |
| characteristic | μ″ | 14.79 | 14.79 | 13.14 | 13.06 | 10.87 | 10.88 |
| before environ- | Q | 4.5 | 4.5 | 4.7 | 4.7 | 4.9 | 4.9 |
| mental test | Assessment | G | G | G | G | NG | NG |
| Post-environmental-test | | 0.483 | 0.485 | 0.496 | 0.501 | 0.484 | 0.491 |
| thickness (mm) | | | | | | | |
| Magnetic | μ′ | 65.51 | 65.10 | 60.90 | 60.60 | 53.99 | 53.70 |
| characteristic | μ″ | 14.07 | 14.21 | 12.57 | 12.50 | 10.76 | 10.65 |
| after environ- | Q | 4.6 | 4.5 | 4.7 | 4.7 | 4.9 | 4.9 |
| mental test | Assessment | G | G | G | G | NG | NG |

| | | | |
|---|---|---|---|
| Method | Invented Method | Conventional Method | Conventional Method |

| | | | | | | |
|---|---|---|---|---|---|---|
| Thickness change rate | 1.68% | 1.46% | 2.27% | 2.24% | 0.41% | 0.41% |

TABLE 2

| | | Example 2 | | Comparative Example 3 | | Comparative Example 4 | | Example 3 | |
|---|---|---|---|---|---|---|---|---|---|
| Fe—Si—Al based alloy powder | | 465 | | 465 | | 465 | | 465 | |
| Phosphorus-containing | | 100 | | 100 | | 100 | | 100 | |
| polyester based resin | | | | | | | | | |
| Block isocyanate | | 3 | | 3 | | 3 | | 3 | |
| Silane coupling agent | | 10 | | 10 | | 10 | | 10 | |
| IPA | | 50 | | 50 | | 50 | | 50 | |
| Flame retardant | | 35 | | 35 | | 35 | | 35 | |
| Pressing pressure (kgf/cm²) | | 6.2 | | 5.9 | | 4.9 | | 6.6 | |
| Appearance | | G | | NG | | G | | G | |
| Environmental test | | 85° C. | 60° C./95% | 85° C. | 60° C./95% | 85° C. | 60° C./95% | 85° C. | 60° C./95% |
| conditions | | | | | | | | | |
| Pre environmental test | | 0.49 | 0.498 | 0.506 | 0.5 | 0.491 | 0.493 | 0.487 | 0.486 |
| thickness (mm) | | | | | | | | | |
| Magnetic | μ′ | 69.87 | 69.89 | 67.65 | 67.31 | 57.84 | 57.47 | 71.54 | 71.55 |
| characteristic | μ″ | 16.10 | 15.71 | 15.46 | 15.25 | 11.82 | 11.82 | 16.87 | 16.91 |
| before environ- | Q | 4.3 | 4.4 | 4.3 | 4.3 | 4.8 | 4.7 | 4.2 | 4.2 |
| mental test | Assessment | G | G | G | G | NG | NG | VG | VG |
| Post-environmental-test | | 0.494 | 0.502 | 0.511 | 0.505 | 0.493 | 0.496 | 0.491 | 0.49 |
| thickness (mm) | | | | | | | | | |
| Magnetic | μ′ | 68.97 | 68.88 | 66.08 | 65.73 | 56.96 | 56.66 | 70.23 | 70.71 |
| characteristic | μ″ | 15.78 | 15.48 | 15.21 | 14.93 | 11.64 | 11.56 | 16.48 | 16.48 |
| after environ- | Q | 4.3 | 4.4 | 4.3 | 4.3 | 4.8 | 4.8 | 4.2 | 4.2 |
| mental test | Assessment | G | G | G | G | NG | NG | VG | VG |

| Method | Invented Method | | Conventional Method | | Conventional Method | | Invented Method | |
|---|---|---|---|---|---|---|---|---|
| Thickness change rate | 0.82% | 0.80% | 0.99% | 1.00% | 0.41% | 0.61% | 0.82% | 0.82% |

### Example 1

A magnetic paint was coated on a PET (polyethylene terephthalate) for release; a magnetic sheet was formed upon drying at 115 degrees Celsius; and another magnetic paint was further coated thereon and dried at 115 degrees Celsius. Those steps were repeated, and a magnetic sheet equivalent to the six layered magnetic sheets was obtained. Subsequently, the obtained magnetic sheet was compressed by being fed ten times between rollers set at 110 degrees Celsius with linear pressure 3.3 kgf/cm2 to discharge air, and was further compressed at 150 degrees Celsius and 5.9 kgf/cm2 to obtain a magnetic sheet as the final product. As a result, the magnetic sheet had a good appearance and magnetic characteristics, as well. The magnetic sheet received quite less changes in thickness and magnetic characteristics though left stably for 168 hours under the high temperature environment of 85 degrees Celsius as well as under the high temperature of 60 degrees Celsius and high humidity environment of 95 percent.

### Example 2

A magnetic paint was coated on a PET for release; a magnetic sheet was formed upon drying at 115 degrees Celsius; and another magnetic paint was further coated thereon and dried at 115 degrees Celsius. Those steps were repeated, and a magnetic sheet equivalent to the six layered magnetic sheets was obtained. Subsequently, the obtained magnetic sheet was compressed by being fed ten times between rollers set at 110 degrees Celsius with linear pressure 3.3 kgf/cm2 to discharge air, and was further compressed at 150 degrees Celsius and 6.2 kgf/cm2 to obtain a magnetic sheet as the final product. That is, in this Example 2, the material of the magnetic paint was different from that in Example 1, and the magnetic sheet was compressed with a higher pressure than Example 1. As a result, the magnetic sheet had a good appearance and magnetic characteristics, as well, though compressed with a higher pressure than Example 1. The magnetic sheet received very quite less changes in thickness and magnetic characteristics though left stably for 168 hours under the high temperature environment of 85 degrees Celsius as well as under the high temperature of 60 degrees Celsius and high humidity environment of 95 percent, because addition of melamine-cyanurate filled the air gaps among the soft magnetic powders to reduce the air amount contained inside the magnetic sheet.

### Example 3

A magnetic paint was coated on a PET for release; a magnetic sheet was formed upon drying at 115 degrees Celsius; and another magnetic paint was further coated thereon and dried at 115 degrees Celsius after the magnetic sheet was compressed by being fed one time between rollers set at 110 degrees Celsius with linear pressure 3.3 kgf/cm2. Those steps were repeated, and a magnetic sheet equivalent to the six layered magnetic sheets was obtained. Subsequently, the obtained magnetic sheet was compressed by being fed ten times between rollers set at 110 degrees Celsius with linear pressure 3.3 kgf/cm2 to discharge air, and was further compressed at 150 degrees Celsius and 6.4 kgf/cm2 to obtain a magnetic sheet as the final product. That is, in this Example 3, the magnetic sheet was compressed with a higher pressure than Example 2 by setting a compressing step after coating and drying the magnetic paint. As a result, the magnetic sheet had a good appearance and magnetic characteristics, as well, though compressed with a higher pressure than Example 2. The magnetic sheet received very quite less changes in thickness and magnetic characteristics though left stably for 168 hours under the high temperature environment of 85 degrees Celsius as well as under the high temperature of 60 degrees Celsius and high humidity environment of 95 percent, because addition of melamine-cyanurate filled the air gaps among the soft magnetic powders to reduce the air amount contained inside the magnetic sheet.

### Comparative Example 1

A magnetic paint was coated on a PET for release; a magnetic sheet was formed upon drying at 115 degrees Celsius; and the magnetic sheet as the final product was obtained by compressed at 115 degrees Celsius and 5.7 kgf/cm2 after six layers of the magnetic sheet was accumulated and compressed by being fed ten time between rollers set at 110 degrees Celsius with linear pressure 3.3 kgf/cm2 to discharge air. That is, Comparative Example 1 was compressed with a pressure lower than that of Example 1. As a result, the magnetic sheet had a bad appearance in which the surface was undulated due to air discharges though compressed with a lower pressure than Example 1. The magnetic characteristics were good when measured at a region not undulated. The air involved among the magnetic sheets was expanded, and the magnetic sheet changed in a way to render the sheet's thickness thicker and came to have deteriorated magnetic characteristics, where the magnetic sheet was left stably for 168 hours under the high temperature environment of 85 degrees Celsius as well as under the high temperature of 60 degrees Celsius and high humidity environment of 95 percent.

### Comparative Example 2

A magnetic paint was coated on a PET for release; a magnetic sheet was formed upon drying at 115 degrees Celsius; and the magnetic sheet as the final product was obtained by compressed at 115 degrees Celsius and 4.3 kgf/cm2 after six layers of the magnetic sheet was accumulated and compressed by being fed ten time between rollers set at 110 degrees Celsius with linear pressure 3.3 kgf/cm2 to discharge air. That is, Comparative Example 2 was compressed with a pressure lower than that of Comparative Example 1 having a bad appearance. As a result, the magnetic sheet had a good appearance, but could not have good magnetic characteristics. The magnetic sheet received quite less changes because the compression did not proceed, where the magnetic sheet was left stably for 168 hours under the high temperature environment of 85 degrees Celsius as well as under the high temperature of 60 degrees Celsius and high humidity environment of 95 percent.

### Comparative Example 3

A magnetic paint was coated on a PET for release; a magnetic sheet was formed upon drying at 115 degrees Celsius; and the magnetic sheet as the final product was obtained by compressed at 115 degrees Celsius and 5.9 kgf/cm2 after six layers of the magnetic sheet was accumulated and compressed by being fed ten time between rollers set at 110 degrees Celsius with linear pressure 3.3 kgf/cm2 to discharge air. That is, Comparative Example 3 was different in the material of magnetic paint from Comparative Example 1. As a result, the magnetic sheet had a bad appearance because undulated regions existed due to air discharges to the surface after the compression though added with melamine cyanurate. Although the magnetic sheet was compressed with a pressure lower than Example 2, the air involved among the magnetic sheets was expanded, and the magnetic sheet changed in a way to render the sheet's thickness thicker and came to have further deteriorated magnetic characteristics in comparison with Example 2, where the magnetic sheet was left stably for 168 hours under the high temperature environment of 85 degrees Celsius as well as under the high temperature of 60 degrees Celsius and high humidity environment of 95 percent.

### Comparative Example 4

A magnetic paint was coated on a PET for release; a magnetic sheet was formed upon drying at 115 degrees Celsius; and the magnetic sheet as the final product was obtained by compressed at 115 degrees Celsius and 4.9 kgf/cm2 after six layers of the magnetic sheet was accumulated and compressed by being fed ten time between rollers set at 110 degrees Celsius with linear pressure 3.3 kgf/cm2 to discharge air. That is, Comparative Example 4 was different in the material of magnetic paint from Comparative Example 1 and was compressed with a pressure lower than that of Comparative Example 1. As a result, the magnetic sheet had a good appearance but could not obtain good magnetic characteristic. The magnetic sheet received quite less changes because the compression did not proceed, where the magnetic sheet was left stably for 168 hours under the high temperature environment of 85 degrees Celsius as well as under the high temperature of 60 degrees Celsius and high humidity environment of 95 percent.

According to those results, it turned out that the manufacturing method proposed in the present invention is extremely advantageous. It is to be noted that although in these Examples 1 to 3 and Comparative Examples 1 to 4, the Fe—Si—Al based alloy powder as the flat soft magnetic powder and the polyester based resin as the binder are used, it is easily presumed that substantially the same results will be obtained even if combinations of soft magnetic powder and resin other than those materials are used.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A method for manufacturing a magnetic sheet comprising the steps of:
coating, on a predetermined substrate, a magnetic paint made from a mixture of an at least flat soft magnetic powder and a polymeric binder dissolved in a solvent and drying the magnetic paint to form a magnetic sheet; and
further coating and drying the magnetic paint on the magnetic sheet dried to be formed.

2. The method for manufacturing the magnetic sheet according to claim 1, wherein the drying step is so made that a containing amount of the solvent is equal to or less than one percent.

3. The method for manufacturing the magnetic sheet according to claim 1, wherein the magnetic paint includes a cross-linking agent, and wherein a drying temperature of the magnetic paint after coating is lower than a temperature of cross-linking starting temperature of the cross-linking agent.

4. The method for manufacturing the magnetic sheet according to any one of claims 1 to 3, wherein the magnetic paint includes a cross-linking agent, and wherein the method for manufacturing the magnetic sheet further comprising the steps of:
compressing the dried and formed magnetic sheet at a temperature equal to or higher than a glass transition temperature of the polymeric binder and lower than a reaction start temperature between the polymeric binder and the cross-linking agent; and
compressing the magnetic sheet at a temperature equal to or higher than the reaction start temperature between the polymeric binder and the cross-linking agent.

5. The method for manufacturing the magnetic sheet according to any one of claims 1 to 3, further comprises the step of compressing the dried and formed magnetic sheet.

6. The method for manufacturing the magnetic sheet according to any one of claims 1 to 5, wherein the magnetic paint includes dispersed particles added so as to disperse to the polymeric binder.

7. The method for manufacturing the magnetic sheet according to claim 6, wherein the dispersed particles are a flame retardant.

8. A magnetic sheet comprising a magnetic paint made from a mixture of an at least flat soft magnetic powder and a polymeric binder dissolved in a solvent, wherein the magnetic sheet is made by coating and drying the magnetic paint on the magnetic sheet formed by drying the magnetic paint after coating the magnetic paint on a predetermined substrate.
